(19) United States
(12) Patent Application Publication
(10) Pub. No.: US 2018/0256299 A1
(43) Pub. Date: Sep. 13, 2018

(54) THREAD DISPENSER

(71) Applicant: Andrew FORRESTER, Edmonton, London (GB)

(72) Inventor: Andrew FORRESTER, Edmonton, London (GB)

(21) Appl. No.: 15/761,035

(22) PCT Filed: Sep. 14, 2016
(86) PCT No.: PCT/GB2016/000165

§ 371 Date: Mar. 16, 2018

(30) Foreign Application Priority Data
Sep. 16, 2015 (GB) 1516422.1

(51) Int. Cl. A61C 15/04; B65H 75/32

(52) U.S. Cl. CPC A61C 15/043; B65H 49/205; B65H 2701/31; B65H 75/32

(57) ABSTRACT

A thread or floss dispenser (1) is disclosed, comprising a container (3) for housing a quantity of thread (11). The container has a substantially flat external wall (16) through which is provided an aperture (12) for the thread to emerge from the interior of the container. A cap (5) is slidably connected to the container so that it can move in a reciprocal manner, along the plane of the external wall, between open and closed positions. The external wall has an elongate recess (13) extending from the aperture towards a terminating point (17) near to the edge of the wall, The edge or underside of the cap carries a blade (27) that, as it passes over the terminating point of the recess towards the closed position, effects cutting of the thread.

### FIELD OF THE INVENTION

This invention relates to a thread dispenser, and particularly, though not exclusively, a dental floss dispenser.

### BACKGROUND OF THE INVENTION

Dental floss is a thread or filament of material used to remove food and dental plaque from between teeth. It is typically provided within a dispenser, comprising a container within which is provided a rotatable spool around which the thread is wound, with one end of the thread emerging through an aperture on an upper surface of the container. A protruding blade is fixed on the upper surface which allows part of the thread to be cut and also helps retain the free-end for subsequent use. A protective cap locates over the upper surface to cover the blade and aperture.

Such dispensers tend to be relatively bulky due to the need to cover the blade with a hollow cap. Sometimes, the thread may come loose from the blade and return back inside the container. The protruding blade may damage clothing, e.g. if the cap comes loose inside a user's pocket. The dispenser may be easily lost or forgotten when travelling.

### SUMMARY OF THE INVENTION

A first aspect of the invention provides a thread dispenser, comprising a container for housing a quantity of thread, the container having an exterior dispensing surface comprising an aperture through which thread in use can emerge from the container, and a cap connected to the container so as to move over the dispensing surface, between an open position and a closed position, the cap edge or underside having a blade provided thereon that cuts the thread when the cap moves from the open position to the closed position.

The dispensing surface may comprise a recess extending from the aperture towards, but not all the way to, an edge of said surface and wherein the cap is arranged to slidably move over the recess such that the blade in use cuts the thread as it passes over the end of the recess.

The dispenser may further comprise a guiding element for guiding thread as it emerges from the dispensing surface aperture to an outlet end, the guiding element being pivotably attached to the container, and located at least partially within the recess, and which rotates upon movement of the cap from the closed position to the open position so that the outlet end is raised above the recess, and which rotates in the opposite direction upon reverse movement of the cap so that the outlet end is positioned adjacent the end of the channel.

The guiding element may be tubular for guiding the thread within, and has a distal end which in use is contacted by the cap as it moves between the open and closed positions.

The dispensing surface recess and the underside of the cap may be shaped so that the guiding element is enclosed within the dispenser when in the closed position.

The dispensing surface may comprise a recessed channel extending from the aperture towards, but not extending all the way to, an edge of said surface and wherein the cap is arranged to slidably move in the direction of the channel such that the blade in use cuts the thread as it passes over the end of the channel.

The cap may be connected to the container by means of at least one sliding connector arranged parallel to the recessed channel.

The dispenser may comprise a spool within the container.

The dispenser may further comprise a key-chain connector attached to the container. The key-chain connector may be removable.

Preferably, the dispenser is a dental floss dispenser, with a quantity of dental floss stored within the container, e.g. wrapped around a spool.

A second aspect of the invention provides a thread dispenser, comprising a container for housing a quantity of thread, the container having a substantially flat external wall through which is provided an aperture for thread to emerge from the interior of the container; and a cap slidably connected to the container so that it can move in a reciprocal manner between open and closed positions, wherein the external wall of the container has an elongate recess extending from the aperture towards a position near the edge of the wall and the edge or underside of the cap carries a blade that, as it passes over edge of the recess, towards the closed position effects cutting of the thread as it passes over the end of the recess.

A third embodiment provides a thread dispenser, comprising a container for housing a quantity of thread, the container having a recessed upper surface within which recess is pivotably attached a guide lever for guiding thread from the container to an outlet end of the lever, and a cap carrying a blade on its edge or underside, which cap is slidably connected to the container so that it can move in a reciprocal manner between open and closed positions over the recess, wherein the guide lever is arranged such that its outlet end is moved upwards by movement of the cap towards the open position, and downwards by movement of the cap towards the closed position, whereby during movement towards the closed position, the outlet end of the guide lever is positioned adjacent a side wall of the recess as the blade passes over it.

### BRIEF DESCRIPTION OF THE DRAWINGS

The invention will now be described, by way of non-limiting example, with reference to the drawings, in which:

FIG. 1 is a perspective view of a dental floss dispenser, according to a first embodiment of the invention;

FIG. 2 is a perspective view of the FIG. 1 dispenser, when opened;

FIG. 3 is an exploded and transparent view of the FIG. 1 dispenser, showing constituent components;

FIG. 4 is a side view of a dental floss dispenser, according to a second embodiment of the invention, shown in a closed position;

FIG. 5 is a side view of the FIG. 4 dispenser, when opened;

FIG. 6 is an exploded perspective view of the FIG. 4 dispenser; and

FIG. 7 is a perspective view of the FIG. 4 dispenser when assembled.

### DETAILED DESCRIPTION OF PREFERRED EMBODIMENTS

Embodiments herein describe a dental floss dispenser. However, the dispenser can also be used for other thread-like materials, and in this respect, the term thread is intended to encompass any filament, cord or tape like material.

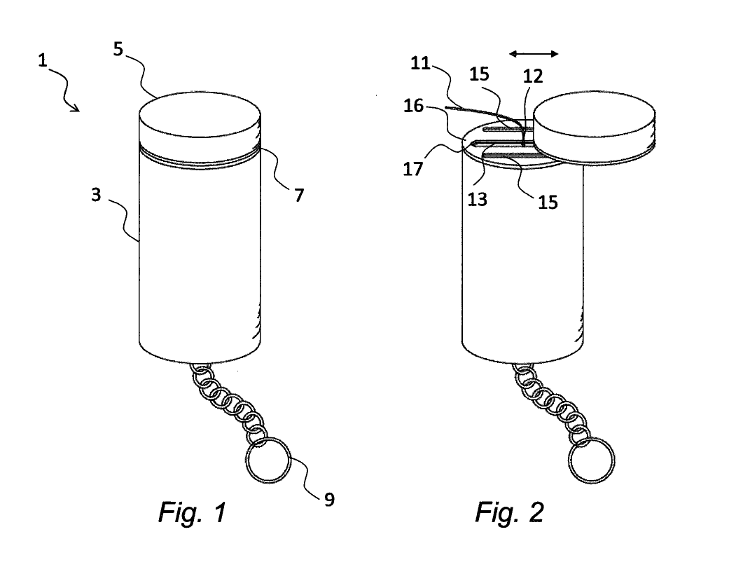

Referring to FIG. 1, a first embodiment dental floss dispenser 1 comprises a cylindrical container 3 and a smaller, cylindrical cap 5. Reference numeral 7 indicates the close interface between the two; as will be described, the container 3 and cap 5 are movable relative to each other, along the interface plane. This Figure shows the dispenser 1 in the closed position. It will be appreciated that the container 3 and cap 5 can be shapes other than cylindrical.

FIG. 2 shows the dispenser 1 in the open position. The cap 5 is slidably connected to the container 3, between the lower surface (not visible) of the former and the upper surface 10 of the latter. The cap lower surface and upper surface 10 are both substantially planar. Two parallel slots 15 in the upper surface 10 provide a means by which lugs or screws extend upwardly from the container 3, through the slots and into the cap 5 where they are fixed, to enable relative sliding of the two parts between the closed and open positions.

An aperture 12 is provided in the approximate centre of the upper surface 10 to allow floss to emerge from the interior. A recessed groove 13, projecting down from the upper surface 10, extends between, and parallel with, the outer slots 15. The groove 13 extends towards the edge 16 of the upper surface 10 (but not all the way) terminating at a point or edge 17 just short of the perimeter edge.

A keychain 9 is connected to the lower surface of the dispenser 1 to enable the dispenser to conveniently connect to a key ring, belt-loop or the like, making the dispenser easy to carry and avoids accidental loss.

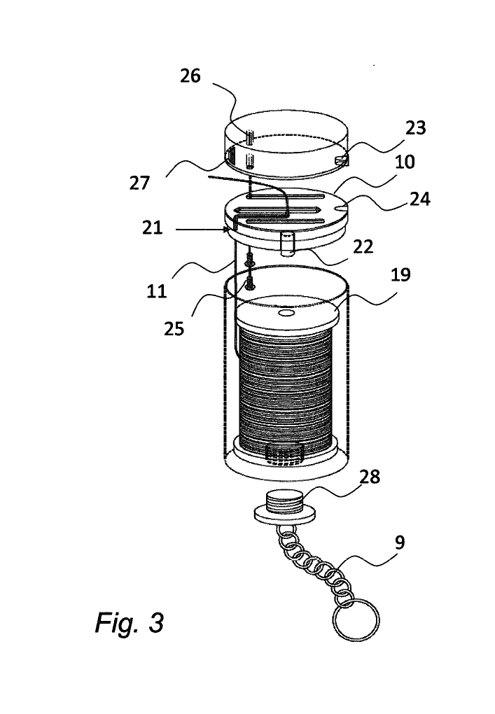

Referring now to FIG. 3, within the container 3 is housed a spool 19 which carries a wound quantity of floss 11. The spool 19 has a central bore which locates between two vertically-oriented spindles 22 allowing the spool to rotate as floss 11 is withdrawn in use. The thread 11 passes upwards through the container 3 and emerges from the aperture 12. The upper surface 10 is provided on a separate end-cap 21 that fits within the upper end of the container 3 to close-off the container. A pair of screw-like lugs 25 are shown which extend upwards through the slots 15 and connect within threaded holes 26 in the cap's lower surface. This is performed prior to the end-cap 21 being fitted to the container 3.

A mechanical stop 23 projects from the lower face of the cap 5 and is shaped to be received in a like-shaped recess 24 when in the closed position. On the lower face of the cap 5, at or near the opposite end to the stop 23, is provided a blade 27 which in use effects automatic cutting of the floss 11. The blade 27 is substantially planar. It is positioned so that the leading edge extends transversely across the groove 13 and will pass over and beyond the terminating point 17 when the cap 5 is slidably moved to the closed position shown in FIG. 1.

As will be appreciated, in use, the user opens the dispenser 1 by relative sliding movement of the cap 5 to the container 3, resulting in the position shown in FIG. 2. The required length of floss 11 is drawn from the container 3, and the cap 5 slidably moved back to the closed position as shown in FIG. 1. This results in the leading edge of the transverse blade 27 passing over part of the exposed floss 11, which remains held within the groove 13, and then cuts the floss as it passes over the point 17 where the groove terminates. The section of floss held within the groove 13 is effectively prevented from returning back into the interior of the container 3.

The keychain 9 can be removable, as shown in FIG. 3. Specifically, it can be attached by means of a bolt 28 which screws into a threaded channel on the lower end of the container.

In summary, the dispenser 1 gives users a safe and reliable way to keep dental floss on their person, ensuring its available when needed e.g. after every meals or snacks. If the keychain 9 is removed, the dispenser 1 can be used like a traditional dispenser and stored in a user's bathroom. The dispenser 1 has an innovative, sliding, open/close lid with cutting action on closing which makes the process of dispensing dental floss much easier (slide open, pull desired length of floss and slide close). By having the dispenser 1 attached to a keyring or belt loop, it is less likely to be forgotten or misplaced.

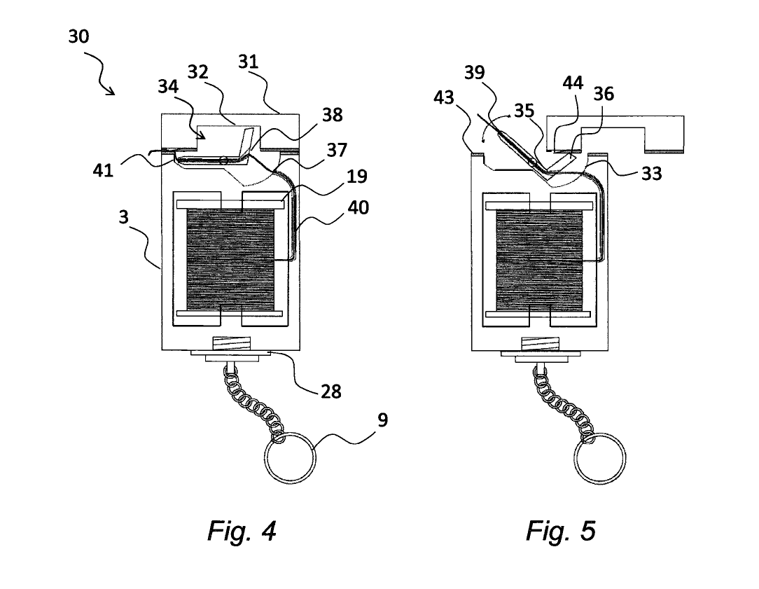

A second embodiment floss dispenser 30 will now be described with reference to FIGS. 4 and 5, which show closed and open positions respectively. This floss dispenser 30 is similar to that of the first embodiment, save for the details that follow.

A cap 31 of the dispenser 30 is similarly slidably mounted on the container 3, but has a recess 32 within its underside; the container upper surface has a deeper recess 33 formed by the shape of its upper wall to define a cavity 34 between the two when in the closed position. Within this cavity 34 is housed a guide lever 35 pivotably mounted to side walls of the recess 33 (not shown). The guide lever 35 is a hollow tube, being generally L-shaped.

At one end of the guide lever 35 is a contact portion 36. Further along the guide lever 35, close to the aperture 37 from which floss emerges from the container 3, is an inlet 38 which communicates with an internal channel. This channel extends to the other end, where there is an outlet 39 at or near the tip. The floss is fed from the spool 19, through an intermediate channel 40, and then through the inlet 38 and channel of the guide lever 35. The floss emerges from the outlet 39.

Referring specifically to FIG. 4, it will be seen that the guide lever 35 is wholly enclosed within the cavity 34 when the cap 31 is closed relative to the container 3. The upwardly projecting contact portion 36 sits within the recess 32 and is retained therein. The outlet 39 in this position sits adjacent the left-most wall 41 of the lower recess 33, just beneath its uppermost edge. Referring to FIG. 5, when the cap 31 is slidably moved to the open position, the left-hand wall of the recess 32 moves the contact portion 36 and rotates the guide lever 35 clockwise, so that the outlet 39 is raised out of the cavity 34. In this position, therefore, floss is made easily accessible to a user, who can withdraw the required length of the floss. Cutting is then effected by closing the cap 31 back to the FIG. 4 position, causing the guide lever 35 to rotate counter clockwise. The withdrawn floss which will lap over the left-most edge 43 is automatically cut by the blade 44 carried on the edge or underside of the cap 31.

The guide lever 35 may be biased to the FIG. 5 position by a spring member, but this is not essential.

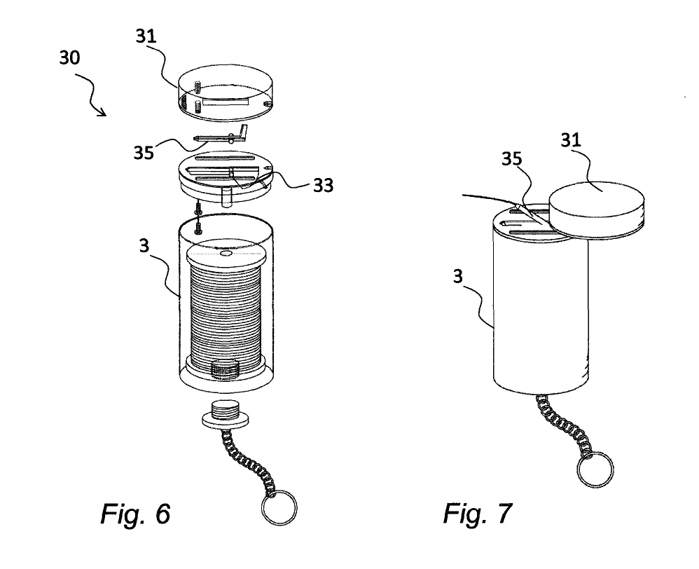

FIGS. 6 and 7 show perspective views of the second embodiment dispenser 30, in exploded and assembled forms respectively. It will be seen from FIG. 6 in particular that the slidable attachment of the cap 31 to an end cap 21 is employed, as are various features present in the first embodiment. The primary difference is the provision of the guide lever 35 within a shaped recess 33 which pivots in response to reciprocal opening and closing movement of the sliding cap 31.

This embodiment offers an alternative solution to the first embodiment.

It will be appreciated that the above described embodiments are purely illustrative and are not limiting on the scope of the invention as should be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A thread dispenser, comprising:
a container for housing a quantity of thread, the container having an exterior dispensing surface including an aperture through which thread in use can emerge from the container, the dispensing surface including a recess extending from the aperture towards, but not all the way to, an edge of dispensing surface; and
a cap connected to the container and arranged to slidably move over the dispensing surface, between an open position and a closed position, the cap including a blade positioned at its edge or underside that cuts the thread when the blade passes over an end of the recess.

2. (canceled)

3. A thread dispenser according to claim 1, further comprising:
a guiding element for guiding thread as it emerges from the dispensing surface to an outlet end of the guiding element, the guiding element being pivotably attached to the container and located at least partially within the recess, and which rotates upon movement of the cap from the closed position to the open position so that the outlet end is raised above the recess when the cap is in the open position, and which rotates in an opposite direction upon movement of the cap from the open position to the closed position so that the outlet end is positioned adjacent the end of the recess.

4. A thread dispenser according to claim 3, wherein the guiding element is tubular for guiding the thread within the guiding element, and the guiding element has a distal end which in use is contacted by the cap as the cap moves between the open and closed positions.

5. A thread dispenser according to claim 3, wherein the recess and an underside of the cap are shaped so that the guiding element is enclosed within the thread dispenser when the cap is in the closed position.

6. A thread dispenser according to claim 1, wherein the cap is connected to the container by at least one sliding connector arranged parallel to the recess.

7. A thread dispenser according to claim 1, further comprising a spool within the container.

8. A thread dispenser according to claim 1, further comprising a key-chain connector attached to the container.

9. A thread dispenser according to claim 8, wherein the key-chain connector is removable from the container.

10. A thread dispenser according to claim 1, wherein the thread dispenser is a dental floss dispenser, with a quantity of dental floss stored within the container.

11. A thread dispenser, comprising:
a container for housing a quantity of thread, the container having a substantially flat external wall through which an aperture for thread to emerge from an interior of the container extends; and
a cap slidably connected to the container so that the cap can move with respect to the container in a reciprocal manner, along a plane of the external wall, between open and closed positions;
wherein the external wall of the container has an elongate channel extending from the aperture towards a terminating point of the channel near to an edge of the external wall, and
wherein an edge or underside of the cap carries a blade that, as the blade passes over the terminating point of the channel, effects cutting of the thread.

12. A thread dispenser, comprising:
a container for housing a quantity of thread, the container including an upper surface, a recess within the upper surface, and a guide lever for guiding thread from the container to an outlet end of the guide lever, the guide lever pivotably attached to the container within the recess, and
a cap carrying a blade on an edge or underside of the cap;
wherein the cap is slidably connected to the container so that the cap can move with respect to the container in a reciprocal manner between open and closed positions over the recess;
wherein the guide lever is arranged such that the outlet end is moved upwards by movement of the cap towards the open position, and such that the outlet end is moved downwards by movement of the cap towards the closed position; and
wherein the outlet end of the guide lever is positioned adjacent a side wall of the recess when the cap moves toward the closed position and the blade is located over the outlet end of the guide lever.
